(19) United States
(12) Patent Application Publication
(10) Pub. No.: US 2024/0154210 A1
(43) Pub. Date: May 9, 2024

(54) HOUSING DEVICE FOR TRACTION BATTERY WITH FLUID-BASED COOLING FUNCTION, COMPRISING EVAPORATION DEVICE WITH MICROCHANNELS

(71) Applicant: KAUTEX TEXTRON GmbH & Co. KG, Bonn (DE)

(72) Inventors: Felix HAAS, Bonn (DE); Moritz LIPPERHEIDE, Bonn (DE); Hartmut Wolf, Konigswinter (DE)

(21) Appl. No.: 17/769,640

(22) PCT Filed: May 4, 2020
(86) PCT No.: PCT/EP2020/062332

§ 371 Date: Apr. 15, 2022

(30) Foreign Application Priority Data
Oct. 17, 2019 (DE) 102019216050.6

(51) Int. Cl. H01M 10/6569; B60L 50/60; F28D 7/16; H01M 10/613; H01M 10/625; H01M 10/6555; H01M 10/6557; H01M 10/6568; H01M 50/209

(52) U.S. Cl. CPC H01M 10/6569; B60L 50/60; F28D 7/16; H01M 10/613; H01M 10/625; H01M 10/6555; H01M 10/6557; H01M 10/6568; H01M 50/209; H01M 2220/20

(57) ABSTRACT

A housing device for a traction battery with fluid-based cooling in a vehicle. The traction battery has a plurality of a battery cells. The housing device includes a housing body, which forms an enclosed interior with a plurality of receiving positions for receiving the plurality of battery cells and a bottom region of which is designed to receive liquid fluid. An evaporation device is included for evaporating the liquid fluid. The evaporation device has a plurality of microchannel structures for forming microchannels. The microchannel structures extend in a vertical direction in the assembled state and have, in their lower region with respect to the vertical direction, at least one inlet opening for receiving liquid fluid from the bottom region of the housing body. During operation, liquid fluid enters the microchannels through the at least one inlet opening and heat is transferred from the battery cells to the liquid fluid in the microchannels. The liquid fluid evaporates in the evaporation device. A traction battery for a vehicle with fluid-based cooling includes a housing device as described above.

The present invention relates to a housing device for a traction battery with fluid-based cooling, more particularly of a vehicle, which traction battery has a plurality of a battery cells, the housing device comprising a housing body, which forms an enclosed interior with a plurality of receiving positions for receiving the plurality of battery cells and a bottom region of which is designed to receive liquid fluid, and an evaporation device for evaporating the liquid fluid.

The present invention also relates to a traction battery for a vehicle with fluid-based cooling, comprising a housing device according to any one of the preceding claims, a plurality of battery cells, which are received in receiving positions in an interior of a housing body of the housing device, and a liquid fluid, which is received in a bottom region of the housing body.

Various types of high-power batteries are known from the prior art. In these high-power batteries, which are used, for example, as traction batteries of vehicles with electric drive, high levels of power are converted during charging and discharging. These high-power batteries presently can be operated with voltages of up to several hundred volts or even up to 1000 volts. Furthermore, charging and discharging currents of several hundred amperes to 1000 amperes presently can occur. For future developments, even higher voltages and currents are possible in principle.

In the high-power batteries, the large charging and discharging currents cause large thermal losses, which lead to heating of the high-power batteries. In order to protect the batteries from thermal damage and to achieve high efficiency, it is important to keep the high-power batteries in a desired temperature range. Heat must be removed from the batteries so that the temperature range is not exceeded. The greater the currents and the associated thermal losses, the more important it is to remove heat from the batteries so that they stay in the desired temperature range even when these large currents occur. Lithium-ion battery cells of today operate best in a narrow temperature range of e.g. 15 to 40° C. at a high level of temperature homogeneity with a temperature fluctuation of 2 to 4° C. within and among the battery cells. Under such conditions, safe operation of the high-power batteries and a long service life with constant performance can be achieved.

In order to ensure these conditions and to make sure that the temperature range is not exceeded, battery cells of high-power batteries of today are cooled during operation, i.e. during charging and/or discharging. Various types of cooling are presently used. For example, liquid cooling by means of a heat exchanger through which a liquid heat-transfer medium flows can be carried out. The heat exchanger is usually located under the battery cells, the heat exchanger being thermally connected to the battery cells by means of contact heat transfer. The heat capacity of the liquid heat-transfer medium is used to absorb, by means of a temperature difference, heat released by the battery cells or by the battery in question as a whole and to release this heat either directly to the environment or by means of a thermal-conditioning circuit.

Water or a water-glycol mixture, for example, is used as the heat-transfer medium, and therefore the heat-transfer medium must be reliably separated from the battery cells.

Similar cooling can also be implemented with air as the heat-transfer medium. Because air, in contrast to water, is not electrically conductive, the battery cells can be in direct contact with the heat-transfer medium, and the heat-transfer medium can, for example, flow around the battery cells. A heat exchanger is therefore not absolutely required.

Basically, in these systems the heat-transfer medium can be actively or passively circulated in order to remove the released heat by convection. In the case of passive circulation, the heat-transfer medium is moved exclusively by a temperature gradient within the heat-transfer medium, while in the case of active circulation the heat-transfer medium is actively circulated in order to remove the heat from the battery cells.

As a further development of the liquid cooling with a heat exchanger in contact with the battery cells, the liquid heat-transfer medium can be evaporated by the absorption of heat from the heat exchanger, resulting in greater heat transfer and, because of the enthalpy of vaporization, high absorption of heat per mass of the heat-transfer medium. After condensation, the heat-transfer medium can be fed back to the heat exchanger in the liquid state.

In some cases, systems for cooling with a liquid heat-transfer medium which do not use a heat exchanger in contact with the battery cells are also being developed, for example in industrial application for high-voltage traction batteries. Similarly to the use of air as the heat-transfer medium, the cooling is achieved by the flow of the liquid heat-transfer medium directly around the components to be cooled. Therefore, an important property of the liquid heat-transfer medium is its dielectricity, because the heat-transfer medium is in direct contact with the battery cells, i.e. with electrically conductive and potential-carrying components. Furthermore, it is also the case for the dielectric, liquid heat-transfer medium that its enthalpy of vaporization and the associated high heat transfer can be utilized if the heat-transfer medium evaporates, during the heat transfer, as a result of the heat input from the battery cells to be cooled. Such cooling is called two-phase immersion cooling.

However, all these systems have disadvantages, and therefore additional improvements are required. For two-phase immersion cooling, the entire cavity of the battery pack must be filled with the liquid heat-transfer medium, causing large additional weight and resulting in corresponding costs for the liquid heat-transfer medium. Furthermore, distribution of a cooling medium between the battery cells, for example, is not possible without, in the case of prismatic cells, interrupting longitudinal pressing of the cells in the battery module. This requires new developments of battery modules with a plurality of battery cells. Furthermore, the installation space required for the battery modules is increased. For systems with active circulation, both weight and energy consumption are increased by additional units such as a compressor or a pump. Furthermore, in the event of a power failure in the vehicle, the battery cells are not cooled, which is problematic and can lead to a build-up of heat, particularly in connection with a previously high output of power. In an extreme case, overheated battery cells can ignite, which is potentially very hazardous.

The present invention addresses the problem of providing a housing device for a traction battery of a vehicle with fluid-based cooling and providing a traction battery having a housing device of this type which allow efficient cooling of battery cells of the traction battery together with low weight and high reliability.

The problem addressed by the present invention is solved by means of a housing device having the features of claim 1. Advantageous embodiments of the housing device are described in the claims dependent on claim 1.

More precisely, the problem addressed by the present invention is solved by means of a housing device for a traction battery with fluid-based cooling, more particularly of a vehicle, which traction battery has a plurality of a battery cells, the housing device comprising a housing body, which forms an enclosed interior with a plurality of receiving positions for receiving the plurality of battery cells and a bottom region of which is designed to receive liquid fluid, and an evaporation device for evaporating the liquid fluid.

The housing device according to the invention is characterized in that the evaporation device has a plurality of microchannel structures for forming microchannels, which microchannel structures extend in a vertical direction in the assembled state and have, in their lower region with respect to the vertical direction, at least one inlet opening for receiving liquid fluid from the bottom region of the housing body, and in that, during operation, liquid fluid enters the microchannels through the at least one inlet opening and heat is transferred from the battery cells to the liquid fluid in the microchannels, whereby the liquid fluid evaporates in the evaporation device.

Furthermore, the problem addressed by the present invention is solved by means of a traction battery having the features of claim 24. An advantageous embodiment of the traction battery is described in the claim dependent on claim 24.

More precisely, the problem addressed by the present invention is also solved by means of a traction battery for a vehicle with fluid-based cooling, comprising a housing device as described above, a plurality of battery cells, which are received in receiving positions in an interior of a housing body of the housing device, and a liquid fluid, which is received in a bottom region of the housing body.

As a result of the design of the microchannels in the evaporation device, the housing device according to the invention allows, during operation, particularly efficient cooling of battery cells received in the receiving positions, high energy input from the battery cells being achieved by means of the evaporation of the liquid fluid. Thus, the traction battery can be efficiently charged and discharged, and high voltages and currents can be used in the charging and discharging.

During operation, the liquid fluid passes from the bottom region of the housing body, through the at least one inlet opening, into the microchannels in question so that it can evaporate there. The liquid fluid evaporates more particularly on insides of the microchannels, by means of which heat is transferred in order to evaporate the liquid fluid. The insides of the microchannels are preferably wetted as extensively as possible so that a large area of the microchannels can be used for the transfer of heat from the battery cells to the liquid fluid and the cooling can work effectively. The channels can be wetted in this way by the movement of the fluid through the microchannels during the evaporation process. For example, evaporated fluid can entrain liquid fluid which has not yet been evaporated, so that this liquid fluid can be deposited on the insides of the microchannels. The wetting depends, inter alia, on the surface tension of the liquid fluid.

During operation, there can be, for example, partial filling of the microchannels with liquid fluid, the microchannels being e.g. 0 to 50% filled with liquid fluid, preferably 0 to 30%, particularly preferably 0 to 15%. The microchannels are preferably filled with the smallest possible amount of liquid fluid in order to keep the total amount of the fluid small. Thus, the fluid channels are partly dipped into the liquid fluid located in the bottom region. The housing device and the microchannels do not have to be completely filled, and thus the traction battery can have a low weight.

However, the microchannels do not have to be partly filled with the liquid fluid during operation. For example, a mixture of liquid fluid and gaseous fluid can form in the region of the at least one inlet opening or can enter the microchannels in question through the at least one inlet opening. This is sufficient in principle for wetting the insides of the fluid channels in order to ensure the cooling effect by the evaporation of the liquid fluid in the microchannels. The total amount of required fluid can thus be further reduced.

Via the at least one inlet opening, the liquid fluid can enter the microchannels, alone or as a mixture with gaseous fluid, in order to bring about continuous transport of the liquid fluid of the microchannels.

As a result of the design of the housing device and of the traction battery, two-phase immersion cooling is formed, wherein a strong cooling effect is achieved by the evaporation of the fluid in the microchannels and by the absorption of the heat of vaporization required therefor. After the evaporation, the fluid condenses again in a condensing device in order to release the heat to the environment and to make possible a fluid circuit which ideally is closed, whereby losses of the fluid can be avoided.

The battery cells can be received, individually or as units/blocks/modules having a plurality of battery cells, in the receiving positions. Thus, a plurality of battery cells can also be jointly received in one receiving position.

The microchannels have dimensions which allow the liquid fluid to flow in from the bottom region and evaporated fluid to rise and flow out. The microchannels can have a rectangular, square, trapezoidal, round, or oval cross-section. The microchannels can have, for example, a diameter or side lengths of less than one centimeter, more particularly of less than five millimeters, for example of approximately two millimeters. The microchannels are open at the top thereof so that the evaporated fluid can flow out of the microchannels at the top. The fluid thus flows from the at least one inlet opening through the microchannels to the top of the microchannels, where the fluid exits as gaseous fluid.

The microchannel structures are used to form the microchannels. The microchannels can be formed directly in the evaporation device or are formed during the assembly of the traction battery by the arrangement of the battery cells in the receiving positions and by the mounting of the evaporation device. The microchannel structures can be lined up or arranged in a matrix, for example. The microchannel structures are preferably evenly distributed in order to evenly cool the battery cells of the traction battery. The evaporation device typically has a vertical extent which is similar to or larger than that of the battery cells in order to allow heat transfer over the greatest possible area. The microchannel structures preferably extend over the total vertical extent of the battery cells.

The assembled state is a state in which the battery cells are inserted into and received in the receiving positions and the evaporation device is arranged together therewith. This is the case in the completed traction battery, for example.

The extending of the microchannels or of the microchannel structures in a vertical direction means that the plurality of microchannel structures has a main direction of extension corresponding to the vertical direction. In addition, the microchannel structures can extend in another direction. The microchannel structures do not have to extend linearly in the vertical direction.

The evaporation device is a heat exchanger or heat-exchange device in which heat is transferred from the battery cells to the liquid fluid so that the liquid fluid can evaporate. An evaporation device of this type is also known as an evaporator. The evaporation device allows heat to be transferred from the battery cells to the liquid fluid. The condensing device is likewise a heat exchanger or heat-exchange device, which absorbs heat from the gaseous fluid and releases this heat to the environment so that the gaseous fluid condenses. A corresponding fluid circuit is thus formed. A condensing device of this type is also known as a vapor condenser or a condensing apparatus.

The microchannels preferably are open only at their ends in the vertical direction and are closed in the peripheral direction, at least in the assembled state, when the battery cells are received in the receiving positions and are arranged together with the evaporation device.

The cooling power of the evaporation device depends in particular on the number of microchannels formed in the assembled state. An increase in the number of microchannel structures increases the number of microchannels and thus the cooling power. A local arrangement of the microchannels can be chosen in order, for example, to ensure optimal heat transfer to the liquid fluid in accordance with local heat generation by the battery cells. The cooling power is also dependent on dimensions of the microchannels formed in the assembled state, and therefore the cooling power can be sized also by means of these dimensions.

The dielectric fluid, which is used in the traction battery and is provided in the housing device, is electrically non-conductive so that electrical insulation of the individual battery cells is formed. The evaporation body is also preferably made of an electrically non-conductive material for the same reasons.

The dielectric fluid preferably has a boiling temperature of to 80° C. at ambient pressure. A maximum cooling effect is achieved in the microchannels by the evaporation of the fluid, and therefore a low boiling temperature is advantageous. As a result of the boiling at these temperatures even at ambient pressure, i.e. at typically approximately one bar, it is possible, for example, to provide a passive cooling circuit as a two-phase cooling circuit of the fluid, without the fluid having to be moved by a pump or a compressor.

The traction battery is preferably a high-power battery which can be operated with voltages of up to several hundred volts or even up to 1000 volts and with charging and discharging currents of several hundred amperes to 1000 amperes. For future developments, even higher voltages and currents are possible in principle. In order to protect the high-power battery from thermal damage and to achieve high efficiency, the battery is kept in a desired temperature range. Battery cells of such traction batteries are now manufactured as lithium-ion battery cells, for example, and operate best in a narrow temperature range of e.g. 15 to 40° C. at a high level of temperature homogeneity with a temperature fluctuation of 2 to 4° C. within and among the battery cells.

In an advantageous embodiment, the evaporation device has at least one evaporation element, and the at least one evaporation element has an evaporation body with a plurality of microchannel structures for forming the microchannels. Because of the design of the at least one evaporation element with the microchannel structures, each evaporation element alone can contribute to the cooling of the battery cells. The microchannel structures formed in the evaporation element can form the microchannels alone or together with adjoining battery cells, and therefore the evaporation device is functional even with one evaporation element. The evaporation device can be scaled in its cooling power by means of the number of evaporation elements, if for example each evaporation element has the same number of microchannel structures. The scaling can be accomplished, for example, by arranging evaporation elements along only one longitudinal side of the battery cells or along both longitudinal sides of the battery cells. Regardless of this, the scaling of the cooling power depends on the number of microchannels formed in the assembled state and their dimensions. The at least one evaporation element is preferably designed to be arranged with at least one of its side surfaces along one or more battery cells.

The microchannel structures are, for example, lined up in the at least one evaporation body, for example in a single row or in a plurality of rows. The at least one evaporation element typically has a longitudinal extent in which the microchannel structures are lined up. In the transverse direction, i.e. between side surfaces of the at least one evaporation element, the at least one evaporation element has a small extent. The at least one evaporation element is typically in longitudinal-side contact with one or more adjoining battery cells in the traction battery. The evaporation body typically has a vertical extent which is similar to or larger than that of the battery cells so that contact therebetween over the greatest possible area is established. The microchannel structures preferably extend over the total vertical extent of the battery cells so that the microchannels have a large extent in the vertical direction.

In an advantageous embodiment, the plurality of microchannel structures is open at at least one side surface of the evaporation element in question, and the microchannels are formed in the assembled state by the arrangement of the evaporation element with at least one of its side surfaces along one or more battery cells. The plurality of microchannel structures can be arranged at least partly in an edge region of the evaporation body and forms the microchannels together with at least one adjoining battery cell. Thus, at least some of the plurality of microchannel structures are closed by the received battery cells in the assembled state, such that the microchannels are formed, and therefore the fluid in the microchannels comes directly into contact with the battery cells. Accordingly, the fluid in the microchannels can directly, and thus very efficiently, absorb the heat released by the battery cells. In this embodiment, the heat is at least partially transferred from the battery cells directly to the liquid fluid. In the case of direct contact of the liquid fluid with the battery cells, i.e. with a surface to be cooled, there is a high level of adaptability of the cooling device to the battery cells and of accompanying tolerances of their surfaces. For heat transfer between two solid bodies, on the other hand, surfaces must be produced with high accuracy and small tolerances in order to achieve good heat transfer by means of contact over as much of the area as possible.

In order to form the microchannels, it is necessary to prevent the passage of fluid between the evaporation body and the battery cell or the battery cells. This can be achieved by direct mechanical contact between the battery cell or the battery cells and the evaporation body in question. The battery cells can thus be supported on the evaporation body in question, and therefore the evaporation body in question can contribute to the structural integrity of the traction battery. Thus, battery modules in which battery cells and evaporation elements are adjacent can be easily formed.

Partial mechanical contact between the battery cell or the battery cells and the evaporation body in question can be sufficient. Alternatively, there can be a small distance between the battery cells and the at least one evaporation element, the distance being chosen to be so small that passage of liquid fluid between the evaporation body and the battery cells is prevented. Because of the small distance between the battery cells and the at least one evaporation element, the battery cells cannot be supported on the evaporation body in question. Accordingly, in the forming of battery modules in which battery cells and evaporation elements are adjacent, structural elements must additionally be included in order to achieve reliable positioning of the battery cells in the battery module and to ensure the structural integrity of the battery module.

For the heat transfer from the battery cells directly to the liquid fluid, the thermal conductivity of the evaporation body is not relevant. Therefore, the evaporation body can, in principle, be made of any material, for example an economical and light plastics material. Accordingly, various manufacturing methods such as injection molding are suitable for the manufacturing of the evaporation element or the evaporation body, by means of which manufacturing methods the evaporation elements or evaporation bodies can be manufactured very easily and economically. In another embodiment, heat can additionally be transferred from the battery cells to the at least one evaporation element or its evaporation body, which heat is then further transferred from the evaporation body to the liquid fluid. In order to achieve good thermal conduction from the battery cells to the liquid fluid in this way, the evaporation element or the evaporation body has high thermal conductivity.

The microchannel structures can each be open at exactly one side surface of the evaporation element in question. Thus, the corresponding microchannels are formed in the assembled state by the arrangement of the evaporation element with the corresponding side surface along one or more battery cells. A subset of the microchannel structures can be open at one of the side surfaces of the evaporation element in question, and another subset of the microchannel structures is open at the opposite side surface of the evaporation element.

In an advantageous embodiment, the plurality of microchannel structures is open at both side surfaces of the evaporation element in question, and the microchannels are formed by the arrangement of the evaporation element with both side surfaces along a plurality of battery cells. Individual microchannel structures are thus open at both side surfaces. The microchannel structures thus extend between adjacent battery cells transversely through the evaporation element and are closed in the assembled state by the received battery cells such that the microchannels are formed. Accordingly, the fluid in the microchannels comes directly into contact with the two adjacent battery cells and, in the microchannels, can directly absorb the heat released by said battery cells. Heat from the adjacent battery cells is transferred directly to the liquid fluid from both side surfaces of the evaporation element. In the assembled state, an arrangement in which each side surface is arranged along one or more battery cells can result. The evaporation body has a thickness, i.e. an extent in the transverse direction between the adjacent battery cells, which corresponds to a corresponding extent of the microchannels. Accordingly, the evaporation body can have a thickness of one centimeter, preferably a few millimeters, particularly preferably approximately two millimeters.

In an advantageous embodiment, the plurality of microchannel structures is closed along both side surfaces of the evaporation element in question such that the microchannels are formed within the evaporation body in question, and the evaporation body is in thermally conductive contact with at least one battery cell during operation. At least some of the plurality of microchannel structures thus form microchannels which are fully surrounded by the evaporation body, such that heat from the battery cells is first transferred to the at least one evaporation element or to the evaporation body. The heat is further transferred from the evaporation body to the liquid fluid in the microchannels. In order to achieve good thermal conduction from the battery cells to the liquid fluid, the evaporation element or the evaporation body preferably has high thermal conductivity. When the microchannels are arranged in such a way, there is no direct heat transfer from the battery cells to the fluid. The material of the evaporation body brings about an even distribution of heat. The evaporation body is made, for example, of a metal having high thermal conductivity.

An evaporation element in which the plurality of microchannel structures is arranged along one of the two side surfaces can be arranged, for example, only with the side surface at which the microchannel structures are open along one or more battery cells. The evaporation element can, for example, be in the form of a capping element of a battery module. An evaporation element in which the plurality of microchannel structures is arranged along both side surfaces is arranged with both side surfaces along one or more battery cells. Accordingly, the evaporation element can be, for example, an intermediate element of a battery module for mounting between two battery cells.

In principle, the evaporation element can have differently arranged and designed microchannel structures in combination. Each of the microchannel structures can individually be open at one or the other of the two sides surfaces or at both side surfaces simultaneously. An evaporation element can also, for example, have a plurality of microchannel structures which are open only at one side surface of the evaporation element, the microchannels being formed in the assembled state by the arrangement of the evaporation element with this side surface along one or more battery cells.

In an advantageous embodiment, the evaporation device has at least one structural element, and the at least one structural element is designed to be arranged, together with at least one evaporation element, along one or more battery cells. The at least one structural element is thus arranged together with at least one evaporation element in a row. Accordingly, the structural element can contribute to the structural integrity of battery modules having mutually parallel battery cells, while the evaporation element contributes to the cooling of the adjacent battery cells. One structural element is particularly preferably arranged between two evaporation elements in each case.

In an advantageous embodiment, the at least one evaporation element is arranged in a region between at least two receiving positions for battery cells. The result is, for example, a sandwich structure in which battery cells received in the receiving positions and evaporation elements alternate. Thus, a maximum contact area between the battery cells and the evaporation elements is achieved. Good heat removal and high cooling power are made possible. If lower heat removal and cooling power are sufficient, one evaporation element can be arranged, for example, between two receiving positions for a battery cell. In the assembled state, the result is an arrangement of the battery cells and evaporation elements in which two battery cells are followed by an evaporation element, two battery cells and another evaporation element.

In an advantageous embodiment, the receiving positions are arranged for the receiving of battery cells such that the received battery cells are at least partly arranged parallel in a row, and the at least one evaporation element is arranged in an end region of one or more receiving positions for the row of the battery cells. The battery cells are thus jointly oriented in their longitudinal direction in the receiving position or the receiving positions such that, for example, their end regions lie on a straight line. The end regions, also called head regions, allow a plurality of battery cells to be jointly contacted by an evaporation element, in which case head-side contact of the battery cells with the evaporation element is established. Thus, a plurality of battery cells can be jointly cooled by means of a single evaporation element. Depending on the desired heat removal and cooling power, it is possible, for example, to arrange an evaporation element only at an end region for each row of receiving positions for the battery cells. Alternatively, an evaporation element can be arranged at each of the two end regions in order to increase the heat removal and cooling power in comparison therewith. The strong cooling effect of the evaporation elements with the microchannels makes it possible to cool the battery cells only via their head side(s). The battery cells can each be arranged individually in a receiving position, or a plurality of battery cells can be received in joint receiving. Joint receiving of a plurality of battery cells is brought about preferably by the receiving of a battery module having a plurality of battery cells in one receiving position. The receiving positions are therefore preferably designed for the joint receiving of a battery module in which the battery cells are fixedly arranged.

In an advantageous embodiment, the at least one evaporation element has a longitudinal extent which is greater than a length of the battery cells at least partly arranged in the receiving positions in a row. The evaporation element thus extends along the head sides of the battery cells, which are arranged in a row, and beyond said row. This allows length compensation, because during operation there is heating of the battery cells as well as of the evaporation elements and this can result in length changes. Thus, permanent reliable heat transfer from the battery cells to the at least one evaporation element is ensured. For example, when battery cells are jointly received in the form of a battery module, the at least one evaporation element can extend beyond the length of the battery module. A battery module of this kind typically comprises end plates, between which the battery cells are retained, such that a mechanical unit is formed. The at least one evaporation element is preferably designed such that it extends at least into a region of the end plates or even therebeyond.

In an advantageous embodiment, the evaporation device has a plurality of evaporation elements, which each extend along a plurality of battery cells and, in the assembled state, are arranged adjacent to each other. The evaporation elements each have a plurality of intermediate elements which, in the assembled state, each extend in the vertical direction between two adjacent battery cells. The intermediate elements of adjacent evaporation elements are arranged at specified distances from each other. The microchannel structures are formed in the specified distances between the intermediate elements of the adjacent evaporation elements. The microchannels are formed in the assembled state by the arrangement of the evaporation elements along the plurality of battery cells. Because of the design of the evaporation elements with the microchannel structures between the intermediate elements of the adjacent evaporation elements, a plurality of evaporation elements is required for cooling the battery cells. In the assembled state, the microchannel structures formed between the evaporation elements form the microchannels together with adjoining battery cells. The evaporation device can be scaled in its cooling power by means of the number of microchannel structures formed and their dimensions and designs. Typically, the number of microchannel structures is increased by means of the number of evaporation elements, if the evaporation elements are designed to form the same number of microchannel structures between their intermediate elements. The evaporation elements can be, for example, of a comb-type design, the intermediate elements being in the form of teeth. The arrangement of the evaporation elements relative to each other ensures that desired distances between the evaporation elements are maintained, whereby the microchannels are formed with desired dimensions. The intermediate elements are retained on a connecting body. It is not necessary that all intermediate elements of adjacent evaporation elements are arranged at a distance from each other.

The microchannel structures are, for example, lined up in the evaporation device, typically in a plurality of rows. The evaporation elements have a transverse extent, i.e. extent in the direction of the adjacently arranged evaporation elements, which in principle can be freely chosen. By means of the transverse extent of the intermediate elements and the corresponding extent of the microchannels, the cooling power of the evaporation device can be scaled. In the longitudinal direction, i.e. in the direction of the adjacently arranged battery cells, the evaporation elements preferably have a small extent so that the battery cells can be arranged with small distances from each other. In the assembled state in the traction battery, the intermediate elements of the evaporation elements are typically in contact, on the inside, i.e. on the sides facing the other intermediate elements of the evaporation element in question, with the adjacent battery cells. The evaporation elements typically have a greater vertical extent than the battery cells in order to bring about contact therebetween over the greatest possible area. The microchannel structures preferably extend over the total vertical extent of the battery cells so that the microchannels have a large extent in the vertical direction. In the assembled state, the adjacent evaporation elements preferably come in contact with each other, whereby automatic positioning of the adjacent evaporation elements relative to each other results.

In an advantageous embodiment, the plurality of evaporation elements is interconnected, or the plurality of evaporation elements can be interconnected by means of a coupling apparatus. Exact positioning of the adjacent evaporation elements relative to each other results. The adjacent evaporation elements preferably have a connecting body, on which the intermediate elements are retained, and the evaporation elements are or can be connected to each other at their connecting bodies.

In an advantageous embodiment, each of the plurality of evaporation elements has at least one connecting body, from which the intermediate elements extend, in the assembled state the at least one connecting body extends along the plurality of battery cells, and in the assembled state the connecting body is arranged below and/or above the battery cells with respect to the vertical direction. The result is, for example, a comb-type design of the evaporation elements, wherein the intermediate elements extend from the connecting body in one direction. The intermediate elements of the evaporation elements can be inserted between the adjacent battery cells from above or from below, such that the connecting body is arranged accordingly above or below the battery cells. In the design of the evaporation elements with two connecting bodies, the intermediate elements extend between the two connecting bodies, and feed-through openings for the feeding through of the battery cells are formed between the intermediate elements.

In an advantageous embodiment, the microchannels at least partly have a surface structure at which the liquid fluid evaporates, such that bubbles are formed, the surface structure preferably being formed in a lower region in the microchannels which is near the bottom region. Accordingly, a boiling process of the liquid fluid can be started in the microchannels. The forming of bubbles promotes transport of liquid fluid in the vertical direction, and thus the insides of the microchannels are continuously wetted with the liquid fluid. As a result, a superheating temperature, i.e. a temperature difference between the surface of the microchannels and the theoretical boiling point of the fluid at the start of the boiling, can be reduced. The surface structure preferably has a microporous design with pore sizes in the range of 3 to 25 micrometers. Depending on the arrangement of the microchannel structures, the surface structure can be formed on the side face of the battery cells and/or on the evaporation element. The surface structure can be formed on the evaporation elements, i.e. on inner surfaces of the microchannels, which inner surfaces are formed by the evaporation elements, thus e.g. on the intermediate elements or on the structural elements, and/or on the surfaces of the battery cells which close the microchannel structures such that the microchannels are formed.

In an advantageous embodiment, the at least one inlet opening has a cross-section which is smaller than the cross-section of a corresponding microchannel structure. The liquid fluid enters the microchannel in question through the at least one inlet opening. By means of the reduced cross-section in comparison with the microchannel, the rate of flow of the fluid into the microchannels can be limited.

In an advantageous embodiment, the at least one inlet opening is in the form of a through-hole in an inlet region of the microchannel structure in question, or the at least one inlet opening is in the form of a lateral recess in an inlet region of the microchannel structure in question. In particular when the microchannel structure in question is bounded by at least one battery cell in order to form the microchannel, the inlet opening can be implemented as a lateral recess in the inlet region in a simple way. Thus, in the fully assembled state, the inlet opening is partly bounded by the corresponding battery cell. In particular when the microchannel structure in question is bounded at both side surfaces by a battery cell in order to form the microchannel, the inlet region preferably has two inlet openings, which are provided on the two side surfaces as lateral recesses in the inlet region. Regardless of this, the inlet region can always have a plurality of individual inlet openings. The inlet region can, for example, form a plate-type termination of the microchannel in question on the side of the microchannel near the bottom region of the housing body. The inlet region preferably has a small thickness or material thickness in the vertical direction, i.e. in the longitudinal direction of the microchannel. However, the inlet region preferably has a thickness of at least approximately 1 mm in the vertical direction. Good sealing on a bottom of the battery cells is thereby made possible. In particular, the sealing of radii on a bottom edge of the cell housings of the battery cells is made possible.

In an advantageous embodiment, the at least one evaporation element is in the form of an insertion element for insertion into the housing body. The design as an insertion element allows easy mounting in the housing body. Furthermore, the at least one evaporation element can also be easily exchanged. In addition, the evaporation elements can be manufactured independently of the manufacturing of the traction batteries and housing devices, because the evaporation elements are inserted therein later. In an advantageous design, the at least one evaporation element is inserted in the vertical direction, i.e. from the top toward the bottom region of the housing device. The at least one evaporation element is preferably in the form of a slide-in element for sliding into the housing body. It is also preferred that the at least one evaporation element is fastened to the housing body in the inserted state, either directly or, for example, by means of the receiving positions for the battery cells. Furthermore, retaining elements or positioning elements are provided on the housing body and/or on the at least one evaporation element in order to position and/or fasten the at least one evaporation element in the housing body. In particular, the at least one evaporation element has, on the top thereof, a stop element, which limits the insertion of the at least one evaporation element. For example, when the at least one evaporation element is inserted, the stop element comes into contact with the tops of the battery cells received in adjoining receiving positions.

In an advantageous embodiment, the evaporation device is designed to support battery cells against each other or to support battery cells on the housing body. For a traction battery, structural strength is also required, for example in order to meet accident safety requirements. For this purpose, a fixed arrangement of the battery cells within the housing body is advantageous. As a result of the evaporation device being designed to support battery cells against each other or to support battery cells on the housing body, such fixed positioning of the battery cells can be achieved. Mechanical forces applied to the housing body of the battery housing can be reliably transferred. The evaporation device therefore additionally has a structural function, for example within battery modules containing layered battery cells or within the housing body. For example, the evaporation elements can each be designed to provide support. For this purpose, the evaporation body of the evaporation elements in question can have support bars extending in the transverse direction in the evaporation body. In the fully assembled traction battery, the support bars extend in the transverse direction between the side surfaces of adjacent battery cells. Accordingly, the support bars can extend between two adjacent receiving positions before the battery cells are inserted. In the longitudinal direction of the evaporation elements, the support bars have a proportion of preferably at least 60 to 95% of the total area of contact of the evaporation elements with adjacent battery cells. The evaporation body preferably has, in its transverse direction, high strength and thus a large supporting effect. Alternatively or in addition, a structural element can be arranged between adjacent battery cells in addition to an evaporation element, in order to provide the support of said battery cells against each other. The design of the evaporation elements with a plurality of intermediate elements likewise allows the support of battery cells on the housing body. In an embodiment of the evaporation apparatus with a plurality of evaporation elements having intermediate elements, between which the microchannel structures are formed, the intermediate elements can provide support of the battery cells against each other or support of the battery cells on the housing body.

In an advantageous embodiment, the at least one evaporation element has a grate structure, wherein the evaporation body has a plurality of struts running in the vertical direction. For example, the struts can alternate with the plurality of microchannel structures, while connecting elements extend between adjacent struts. Accordingly, the plurality of microchannel structures in the evaporation body forms microchannels, which extend in the transverse direction through the evaporation element and alternate, for example, with support elements which, here, form the struts. The evaporation element preferably has a small thickness in order to form the microchannels by means of the microchannel structures in contact with the adjoining battery cells. The adjoining battery cells contact the corresponding evaporation element on both sides. The connecting elements extend between two struts in the longitudinal direction of the corresponding evaporation element, for example through the microchannel structures. Alternatively, the connecting elements can extend around the microchannel structures, for example as an end-arranged plate. The connecting elements bring about positioning and retention of the struts. Alternatively, the struts can be in the form of intermediate elements, such that free spaces for receiving the battery cells are formed between the intermediate elements.

In an advantageous embodiment, the housing device has a supporting plate, which extends in the horizontal direction in the housing body and forms a vertical support for the battery cells and/or the evaporation device, the supporting plate having at least one fluid passage between a plenum, which is located therebelow, and the plurality of microchannel structures. The strength of the housing device can be increased by means of the supporting plate. Furthermore, fastening of the battery cells and of the evaporation device in the housing body is simplified. The fluid passages in the supporting plate are preferably larger than the cross-sections of the microchannels formed by the microchannel structures, so that simple flow of the liquid fluid into the microchannels is made possible. The fluid passages are arranged in the supporting plate preferably in correspondence with the arrangement or positioning of the microchannel structures. Individual fluid passages can be used to connect a plurality of microchannel structures to the plenum, which is formed below the supporting plate in the bottom region. The plenum is a region in the bottom region of the housing body which is bounded above by the supporting plate. The fluid passages are preferably in the form of slots in the supporting plate. The fluid passages can be oriented in a direction parallel or perpendicular to a row orientation of the microchannel structures of the evaporation device.

In an advantageous embodiment, the evaporation element forms a wall region of the housing body. The evaporation element thus forms a structural part of the housing device. Because an additional wall is not used in the wall region, the housing device as a whole can be manufactured with low weight and small dimensions. The evaporation element preferably additionally has cooling elements, more particularly cooling fins, which extend on the outside of the housing device, i.e. in a direction away from the interior.

In an advantageous embodiment, the housing device has at least one filling element, which is arranged in the interior enclosed by the housing body. Dead volumes, which can result e.g. from the fastening of the battery cells in the housing body, can thereby be reduced in order to reduce the total weight of the traction battery during operation by the reduction of the fluid used. This applies in particular when module end plates of battery modules having a plurality of battery cells are mounted in the housing body. The module end plates often have only a small extent in the vertical direction and in the transverse direction in comparison with the battery cells, and this can result in corresponding dead volumes. As a result of the at least one filling element, the total amount of required fluid for receiving in the interior enclosed by the housing body can be reduced. The at least one filling element particularly preferably has a density less than the density of the fluid in the liquid state. The filling element is preferably made of a foam, for example EPP (expanded polypropylene), more particularly with closed cells. Alternatively, the filling element has at least one inner cavity so that the filling element has only a low total weight. The inner cavity is additionally preferably gas-filled, more particularly air-filled. Alternatively, the inner pressure of the inner cavity can range from a pressure which is reduced in comparison with standard pressure, down to a vacuum. A distribution of the liquid fluid in the region of the filling element can be prevented, whereby the free total volume in the housing device and thus the required total amount of the fluid are reduced. The filling element is preferably arranged such that, during operation, it is at least partly dipped into the liquid fluid.

In an advantageous embodiment, an outlet for evaporated, gaseous fluid and an inlet for condensed, liquid fluid are formed on the housing body. This allows a connection to a condensing device so that the evaporated fluid can efficiently condense outside of the housing device. The inlet and the outlet are preferably in the form of connection pieces in the housing body.

Alternatively, a condensing device can be arranged within the housing body, for example as a heat-exchange device arranged in an upper region of the housing body. In particular, the condensing device is an integral part of the housing body. Condensed fluid can thus simply drip, in the liquid state, back into the bottom region, onto the battery cells and/or onto the evaporation device.

In an advantageous embodiment, the traction battery is filled with liquid fluid at a filling ratio of a whole system at a system temperature of 50° C. of 20 to 60 volume percent, preferably 30 to 40 volume percent, in relation to the total volume of the whole system. Thus, the amount of fluid used can be reduced in comparison with conventional immersion cooling in which components to be cooled are completely immersed in the liquid fluid. Accordingly, the traction battery can have a low weight. The whole system also comprises, in addition to the traction battery, typically at least one condensing device, which is arranged outside of the housing device, and connecting hoses between the housing device and the condensing device. If necessary, the whole system can comprise a reservoir which, however, does not contribute to the total volume of the whole system. As a result of the specified filling ratio, sufficient heat transfer away from the battery cells can be achieved, for example, even before boiling operation, in which the fluid evaporates in the microchannels and causes wetting of the microchannels as a result of the entraining of liquid fluid. During boiling operation, the boiling of the liquid fluid in the microchannels and the rising of the evaporated fluid in the microchannels result in good, preferably complete, wetting of the insides of the microchannels so that these wetted regions of the microchannels contribute to the cooling of the battery cells. Accordingly, a vapor quality of the fluid of over 10% can be achieved at the upper end of the microchannels at the outlet. Overall, the cooling effect of the evaporation device can be ensured at all times. The filling of the traction battery with liquid fluid is basically independent of possible filling of the microchannels with liquid fluid. Both can be set independently of each other.

In an advantageous embodiment, the traction battery has a quality sensor, which is in contact with the fluid at least during operation and senses at least one electrical property of the fluid, more particularly the breakdown voltage and/or the electrical conductivity of the fluid. By the monitoring of the at least one electrical property of the fluid, the function of the cooling system can be ensured. In particular, e.g. short circuits due to increased electrical conductivity of the fluid can be prevented, if, for example, the liquid fluid flows directly around the battery cells received in the housing device. The at least one electrical property of the fluid can be monitored in the liquid state or in the gaseous state of the fluid, i.e. in a liquid phase or in a vapor phase of the fluid. The quality sensor is preferably designed, or is controlled by a controller, to monitor the at least one electrical property of the fluid and, if necessary, to output a signal indicating that the quality of the fluid, i.e. the at least one electrical property, is impaired, so that the fluid can be topped up and/or exchanged in order to ensure the quality of the fluid during operation. For this purpose, the quality sensor can be designed, for example, to output a corresponding signal when the breakdown voltage falls below a specified value, for example approximately 3 kV/mm, and/or when the electrical conductivity exceeds a specified value, for example approximately 10⁻¹⁵ S/m. Signals can particularly preferably be output for a plurality of limit values of the breakdown voltage and/or of the electrically conductivity, in order to output different warnings relating to the quality of the fluid. Alternatively, one or more values of the at least one electrical property are continuously sensed and are then output to a control unit of the vehicle or of the traction battery and are further processed there. Alternatively or additionally, an electrical property of the fluid can be sensed by means of the quality sensor, and another electrical property of the fluid is derived therefrom. For example, a correlation between different electrical properties of the fluid can be determined by means of prior tests/calculations, so that the one electrical property of the fluid can be sensed by means of the quality sensor and the other electrical property of the fluid can be derived therefrom. The quality sensor can be positioned such that it is always in contact with the fluid, or only during operation, for example when the fluid is in its gaseous phase in the housing device, and the quality sensor comes into contact therewith.

In an advantageous embodiment, the quality sensor is mounted on or in the housing device. The quality sensor is particularly preferably arranged in the bottom region of the housing body for receiving the liquid fluid, whereby continuous contact of the quality sensor with the liquid fluid is ensured during operation.

Additional advantages, details and features of the invention are clear from the embodiments explained below. Specifically, the drawings show:

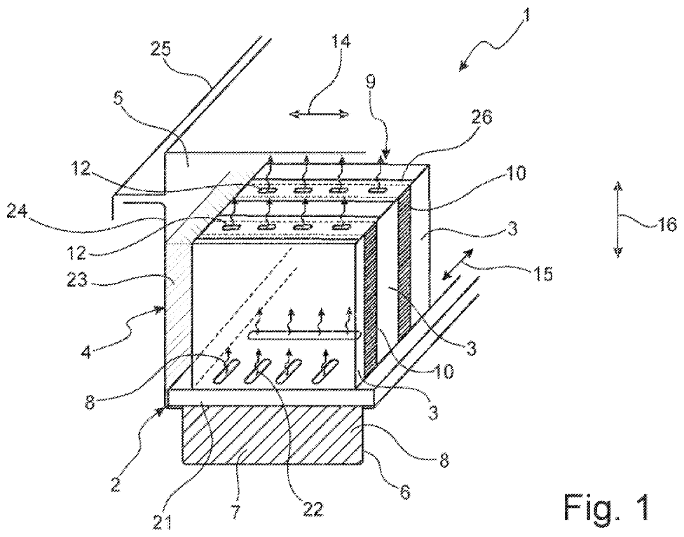

FIG. 1: a schematic partial illustration of a traction battery according to the invention, according to a first embodiment of the present invention, comprising a housing device, a plurality of battery cells, and a liquid fluid provided in the housing device;

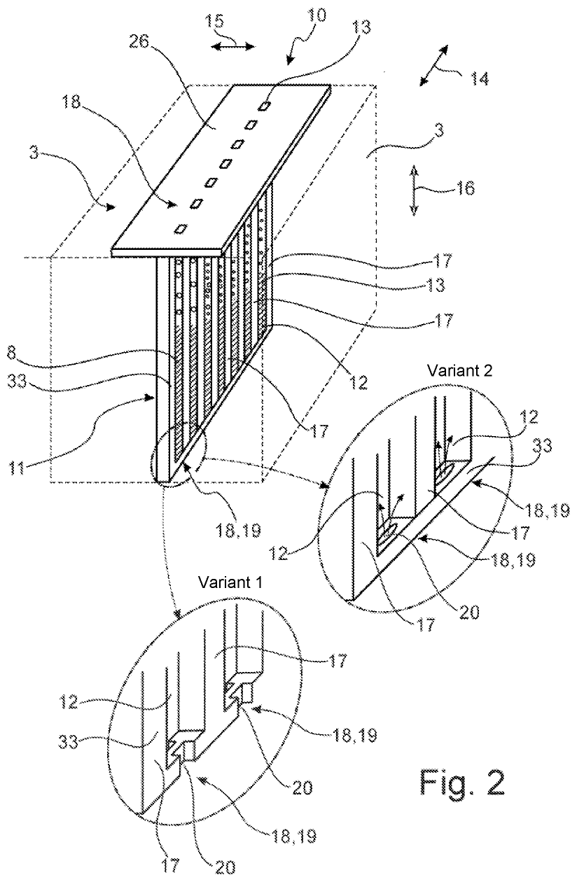

FIG. 2: a schematic illustration of an evaporation element of the housing device of the first embodiment from FIG. 1, with microchannel structures for forming microchannels and with fluid provided in the housing device, with two variants of the inlet regions;

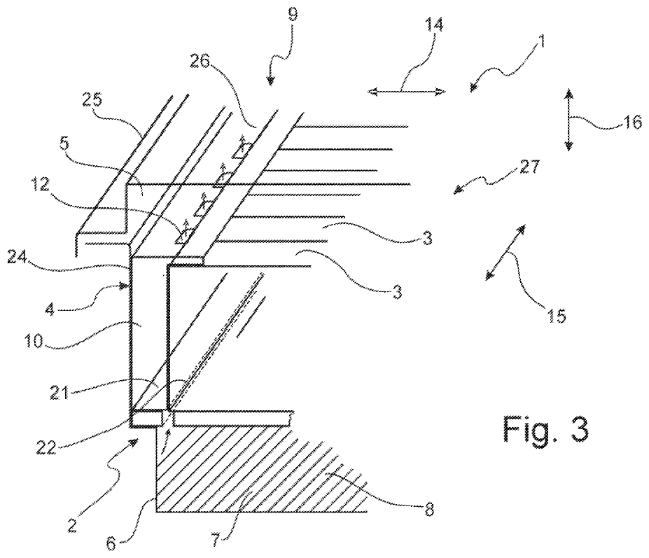

FIG. 3: a schematic partial illustration of a traction battery according to a second embodiment of the present invention, comprising a housing device, a plurality of battery cells, which are connected to form a battery module, and a liquid fluid provided in the housing device;

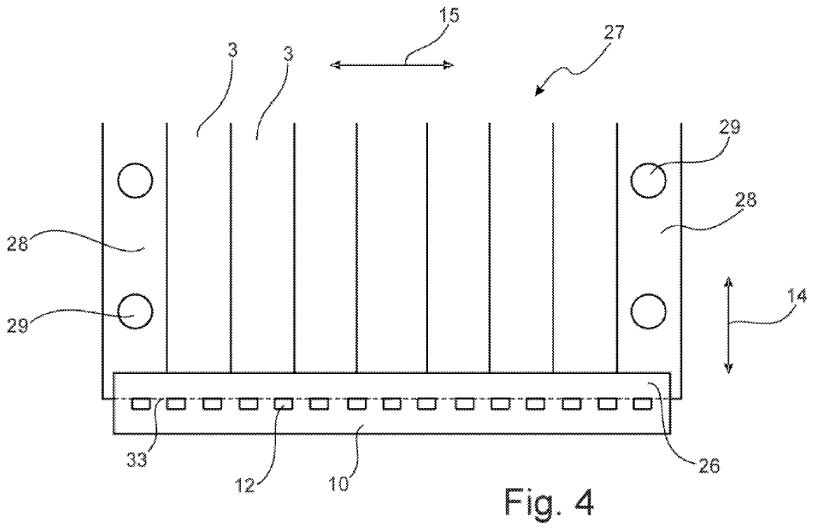

FIG. 4: a schematic partial illustration of the battery module from FIG. 3, with a plurality of battery cells, which are retained between module end plates, and with an evaporation element adjacent thereto;

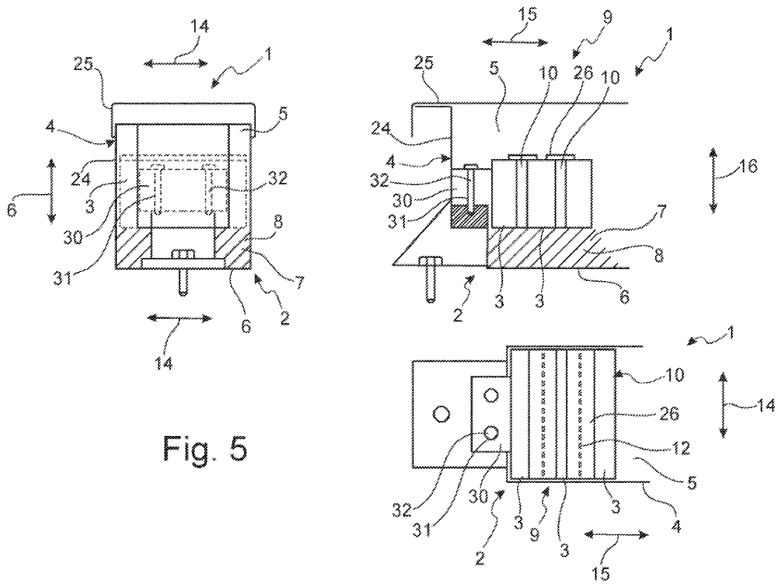

FIG. 5: a schematic partial illustration of a traction battery according to a third embodiment of the present invention, comprising a housing device, a plurality of battery cells, and a liquid fluid provided in the housing device, in three views;

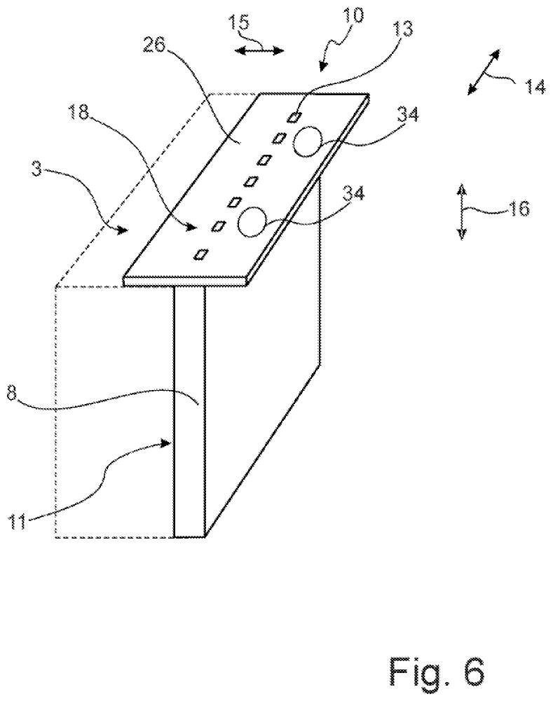

FIG. 6: a schematic illustration of an evaporation element of a fourth embodiment based on the evaporation element of the housing device of the first embodiment from FIG. 1, the evaporation element being a module capping element;

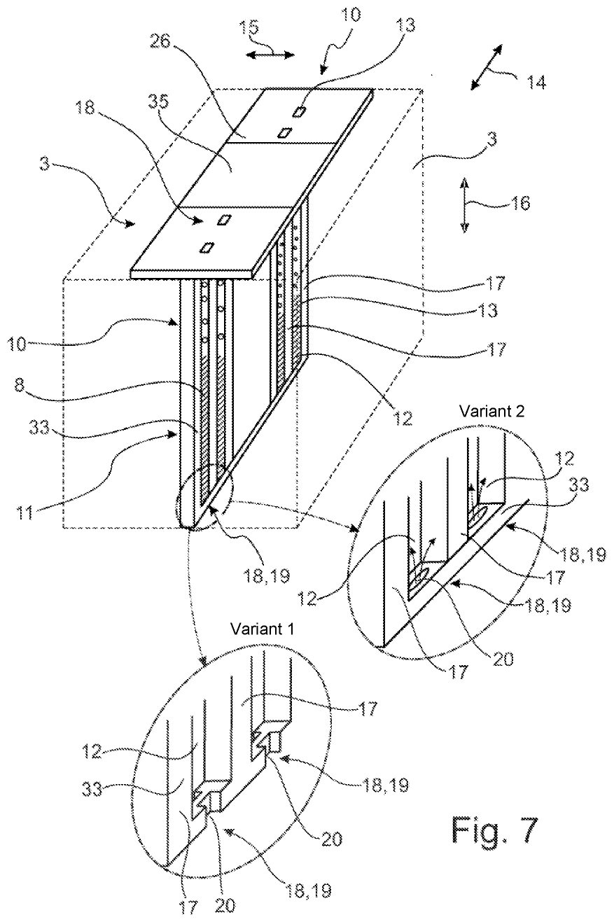

FIG. 7: a schematic partial illustration of a battery module of a traction battery according to a fifth embodiment of the present invention, with an arrangement of two evaporation elements each in correspondence with the evaporation element from FIG. 2 and a structural element, which are arranged in a row between two battery cells;

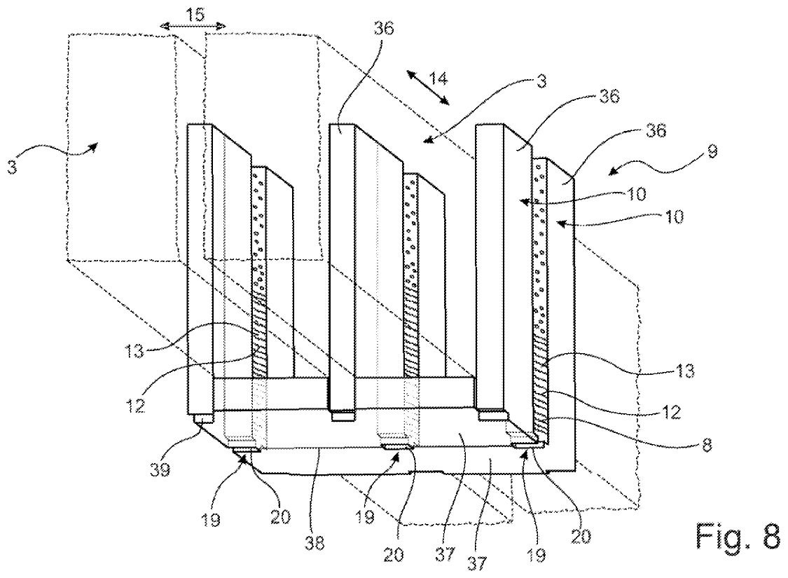

FIG. 8: a schematic partial illustration of an evaporation device of a traction battery according to a sixth embodiment of the present invention, the evaporation device having a plurality of comb-type evaporation elements with support elements, wherein a battery cell is arranged between adjacent support elements of an evaporation element, and microchannel structures for forming microchannels are formed between support elements of adjacent evaporation elements; and

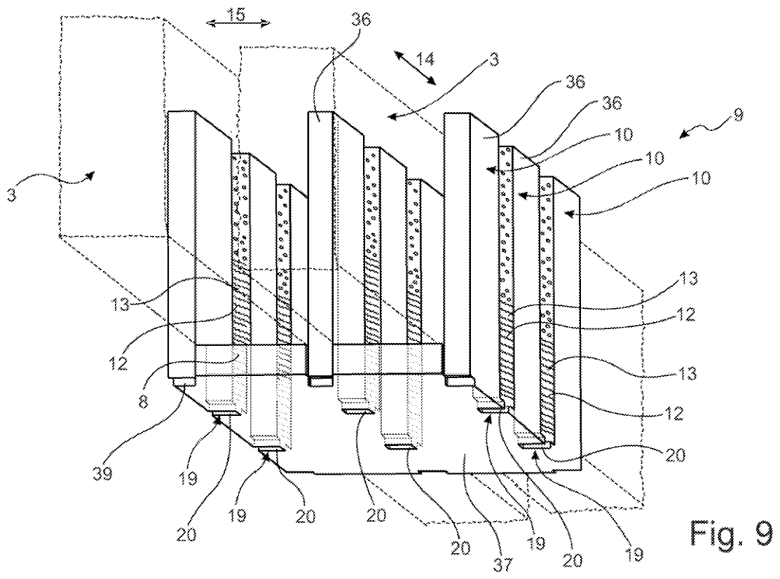

FIG. 9: a schematic illustration of an evaporation device of a traction battery according to a seventh embodiment of the present invention, comprising intermediate elements, between which battery cells are arranged in the one plane direction and between which microchannel structures for forming microchannels are arranged in the other plane direction.

In the description below, the same reference signs refer to the same components or to the same features, and therefore a description regarding a component with respect to one figure also applies to the other figures, so that a repeated description is avoided. Furthermore, individual features that have been described in connection with one embodiment can also be used separately in other embodiments.

FIGS. 1 and 2 show a traction battery 1 and a housing device 2 according to a first embodiment of the present invention. The housing device 2 is part of the traction battery 1.

The traction battery 1 is a traction battery 1 for an electrically drivable vehicle and has fluid-based cooling, as explained in detail below. The traction battery 1 is a high-power battery operated with voltages of up to several hundred volts or even up to 1000 volts and with charging and discharging currents of several hundred amperes to 1000 amperes.

The traction battery 1 also comprises a plurality of battery cells 3. The housing device 2 additionally comprises a housing body 4, which forms an interior 5 with a plurality of receiving positions for receiving the battery cells 3. FIG. 1 shows the battery cells 3 received in the interior 5 of the housing body 4 of the housing device 2. In this embodiment, the battery cells 3 are individually received in the respective receiving positions, which are not shown. The receiving positions each define a position of a battery cell 3. The receiving positions can optionally be assigned individual mounting or retaining means for receiving, fastening or retaining the battery cells 3 therein. Battery cells 3 of such traction batteries 1 are now manufactured as lithium-ion battery cells, for example, and preferably operate in a temperature range of e.g. 15 to 40° C. at a high level of temperature homogeneity with a temperature fluctuation of 2 to 4° C. within and among the battery cells 3.

The housing body 4 of the housing device 2 has a bottom region 6, which is designed to receive liquid fluid 8. In the traction battery 1 shown in FIG. 1, the liquid fluid 8 is received in the bottom region 6 of the housing body 4. The liquid fluid 8 is a dielectric fluid, which is used in the traction battery 1 and, accordingly, is provided in the housing device 2. The liquid fluid 8 is electrically non-conductive, so that electrical insulation of the battery cells 3 is formed. The dielectric fluid 8 has a boiling temperature of 10 to 80° C. at ambient pressure.

The housing device 2 of the first embodiment also comprises an evaporation device 9 having a plurality of individual evaporation elements 10, which, during operation, are in contact with the battery cells 3 inserted into and received in the receiving positions. The evaporation device 9 is a heat exchanger or heat-exchange device in which heat is transferred from the battery cells 3 to the liquid fluid 8 such that the liquid fluid 8 can evaporate, as described in detail below. The individual evaporation elements 10 can be in a distributed arrangement.

According to the first embodiment, in each region between two receiving positions for battery cells 3 there is an evaporation element 10. The result is a sandwich structure in which receiving positions for battery cells 3 and evaporation elements 10 alternate. Accordingly, the battery cells 3 received in the receiving positions and the evaporation elements 10 are arranged in alternation in the traction battery 1. One of the evaporation elements 10 of the first embodiment is shown as an example in FIG. 2.

The evaporation element 10 shown in FIG. 2 comprises an evaporation body 11 having a plurality of microchannel structures 12 for forming microchannels 13. The microchannel structures 12 are formed in a single row in the evaporation body 11. The evaporation body 11 is made of an electrically non-conductive material.

Each of the evaporation elements 10 has a longitudinal extent, i.e. an extent in a longitudinal direction 14, in which the microchannel structures 12 are lined up. In the transverse direction 15, i.e. between side surfaces 33 of the evaporation element 10, the evaporation element 10 has a small extent. The evaporation elements 10 are each in contact, on longitudinal sides, with two adjacent battery cells 3 of the traction battery 1, as shown in FIG. 1. The battery cells 3 and the evaporation elements 10 have a similar vertical extent.

In this embodiment, the evaporation elements 10 are in the form of insertion elements for insertion into the housing body 4. In particular, the evaporation elements 10 are in the form of slide-in elements. In this embodiment, the insertion or sliding in of the evaporation elements 10 occurs in the vertical direction 16, i.e. from a top to the bottom region 6 of the housing device 2. The introduced evaporation elements are fastened to the housing body 4 in a way which is not shown. Furthermore, each evaporation element 10 has, at the top thereof, a stop element 26, which limits the insertion of the evaporation elements 10. When the evaporation elements 10 are inserted, the stop element 26 comes into contact with the tops of battery cells 3 received in the receiving positions, as shown in FIG. 1.

The microchannel structures 12 extend in a vertical direction 16 in the evaporation body 11. Accordingly, the microchannel structures 12 have a main direction of extension corresponding to the vertical direction 16. In addition, the microchannel structures 12 can also extend in another direction. The microchannel structures 12 do not have to extend linearly in the vertical direction 16. The microchannel structures 12 extend over the total vertical extent of the evaporation elements 10 and, accordingly, also over the total vertical extent of the battery cells 3.

The microchannel structures 12 are open at both side surfaces 33 of the evaporation elements 10 and extend between the opposite side surfaces 33 of the evaporation element 10 in question. The microchannel structures 12 thus extend through the evaporation element 10 in question in the transverse direction 15. In the assembled state, the microchannels 13 are formed by the arrangement of the evaporation element 10 with its side surfaces 33 along one or more battery cells 3. The microchannel structures 12, which are open at both side surfaces 33 of the evaporation element 10, are thus bounded and also closed, in the assembled state, by the battery cells 3 adjoining the side surfaces 33. As a result, the liquid fluid 8 in the microchannels 13 can come directly into contact with the battery cells 3. The microchannels 13 are open at their ends in the vertical direction 16, and the microchannels 13 are closed in the peripheral direction in the assembled state, when the battery cells 3 are received in the receiving positions, the microchannels 13 thus being completely formed.

The evaporation elements 10 are manufactured from an economical and light plastics material in a manufacturing method such as injection molding. The evaporation elements 10 have a small thickness between their two side surfaces 33, i.e. the extent of the evaporation elements 10 in the transverse direction 15 between the side surfaces 33 is small, for example approximately one centimeter, preferably a few millimeters, particularly preferably approximately two millimeters. The thickness of the evaporation elements 10, specifically the thickness of the evaporation body 11, defines the extent of the microchannels 13, which are formed therein, in the transverse direction 15.

The microchannels 13 have a rectangular or square cross-section. In this embodiment, the microchannels 13 have side lengths of less than one centimeter, more particularly less than five millimeters, for example approximately two millimeters.

The microchannels 13 at least partly have a surface structure at which the liquid fluid 8 evaporates, such that bubbles are formed, the surface structure preferably being formed in a lower region in the microchannels 13 which is near the bottom region 6. The surface structure has a microporous design with pore sizes in the range of 3 to 25 micrometers. The surface structure is formed both on the evaporation body 11 and on the battery cells 3.

The evaporation body 11 of each of the evaporation elements 10 is designed as a support element for supporting the battery cells 3 against each other. The evaporation elements 10 thus have a structural function within the housing body 4. Mechanical forces applied to the housing body 4 of the battery housing 2 can be reliably transferred. The evaporation body 11 comprises corresponding support bars 17, hereinafter also called struts 17, which extend in the transverse direction 15 in the evaporation body 11; i.e. in the fully assembled traction battery 1 the support bars 17 extend in the transverse direction 15 between longitudinal sides of adjacent battery cells 3. In this embodiment, the support bars 17 have, in the longitudinal direction 14 of the evaporation elements 10, a proportion of preferably not more than 10 to 20% of a total area of contact of the evaporation elements 10 with the adjacent battery cells 3. Accordingly, microchannel structures 12 formed in the edge region of the evaporation element 10 in question have, in the longitudinal direction of the evaporation elements 10, a proportion of preferably approximately 80 to 90% of the total area of contact with the adjacent battery cells 3. Therefore, the evaporation body 11 has, in its transverse direction 15, high strength and thus a large supporting effect.

As a result of this design, the corresponding evaporation element 10 has a grate structure in which the support bars 17 alternate, as struts running in the vertical direction 16, with the microchannel structures 12. The evaporation element preferably has a small thickness in order to form the microchannels 13 by means of the microchannel structures 12 in contact with the adjoining battery cells 3. The adjoining battery cells 3 contact the side surfaces 33 of the evaporation element 10 in question on both sides.

In addition, connecting elements 18 extend between adjacent struts 17. The connecting elements 18 extend between two struts 17 in the longitudinal direction 14 of the corresponding evaporation element 10, at an end near the bottom region 6 in the vertical direction 16, through the microchannel structures 12. At the end of the evaporation element 10 remote from the bottom region 6 in the vertical direction 16, the stop element 26 is simultaneously used as a connecting element. The connecting elements 18, 26 bring about positioning and retention of the struts 17. In this embodiment, the connecting elements 18 are formed at the upper and lower ends of the microchannel structures 12 with respect to the vertical direction 16.

The microchannel structures 12 each have, on the side thereof near the bottom region 6 of the housing body 4, i.e. at their lower end with respect to the vertical direction 16, an inlet region 19 having two inlet openings 20. The inlet openings 20 have a cross-section which is smaller than the cross-section of an associated microchannel structure 12. The inlet openings preferably have a cross-section which corresponds approximately to one fourth of the cross-section of the microchannel 13 in question. In this embodiment, the lower connecting element 18 with respect to the vertical direction 16 simultaneously forms the inlet region 19.

The inlet region 19 forms a plate-type termination of the microchannel 13 in question on the side of the microchannel 13 near the bottom region 6 of the housing body 4. The inlet region 19 has a thickness of at least approximately 1 mm in the vertical direction 16. According to variant 1, which is shown in FIG. 2 accordingly, the inlet openings 20 are in the form of lateral recesses in the inlet region 19. Thus, in the fully assembled state, the inlet openings 20 are partly bounded by the corresponding adjoining battery cells 3. The inlet openings 20 can alternatively be through-holes in the inlet region 19, as shown as variant 2 in FIG. 2.

In addition, the housing device 2 comprises a supporting plate 21, which extends in a horizontal plane in the housing body 4 and forms a vertical support for the battery cells 3 and for the evaporation elements 10. As shown in FIG. 1, a plurality of slots 22 is formed in the supporting plate 21 as fluid passages between a plenum 7, which is located below the supporting plate 21, and the microchannel structures 12. In this embodiment, the fluid passages 22 are arranged in the supporting plate 21 in correspondence with the arrangement and positioning of the microchannel structures 12, and individual fluid passages 22 connect a plurality of microchannel structures 12 to the plenum 7. In this embodiment, the fluid passages 22 are oriented in a direction perpendicular to the orientation of the evaporation elements 10. The fluid passages 22 in the supporting plate 21 are preferably larger than the cross-sections of the microchannels 13 formed by the microchannel structures 12. The plenum 7 is formed by a part of the bottom region 6 in which liquid fluid 8 is received.

In addition, the housing device 2 has a filling element 23, as shown in FIG. 1, which is arranged in the interior 5 enclosed by the housing body 4 in order to reduce dead volumes. The filling element 23 has a density less than the density of the liquid fluid 8. The filling element 23 is preferably made of a foam, for example EPP (expanded polypropylene), more particularly with closed cells. Alternatively, the filling element 23 is a hollow body having an inner cavity so that the filling element 23 has only a low total weight. The inner cavity is preferably gas-filled, more particularly air-filled.

Alternatively, the inner pressure of the inner cavity can range from a pressure which is reduced in comparison with standard pressure, down to a vacuum. The filling element 23 is arranged such that, during operation, it is at least partly dipped into and displaces the liquid fluid 8, whereby the level of the liquid fluid 8 in the bottom region 6 rises.

Furthermore, an outlet for evaporated, gaseous fluid and an inlet for condensed, liquid fluid 8 are formed on the housing body 4 (the outlet and the inlet are not shown in the figures). By means of the outlet and the inlet, the traction battery 1 is connected to a condensing device (not shown), in which evaporated fluid is condensed outside of the housing device 2. The inlet and the outlet are preferably in the form of connection pieces in the housing body 4.

As is also shown in FIG. 1, the housing body 4 comprises a lower shell 24 and an upper shell 25, which, after the insertion of the battery cells 3, the evaporation device 9, the supporting plate 21 and the filling element 23, are releasably or non-releasably interconnected in order to form the housing body 4. The liquid fluid 8 can also be introduced into the housing device 2 via the inlet or the outlet before the lower shell 24 and the upper shell 25 are connected or thereafter.

The function for cooling the traction battery 1 is explained below. As a result of the design of the housing device 2 and of the traction battery 1 and the corresponding filling with liquid fluid 8 together with the condensing device connected to the traction battery 1, two-phase immersion cooling is formed, which is explained in detail in the description below.

The traction battery 1 is partly filled with liquid fluid 8, which, in an idle state, is located in the bottom region 6. The liquid fluid 8 is introduced until a filling ratio of a whole system at a system temperature of 50° C. of 20 to 60 volume percent, preferably 30 to 40 volume percent, in relation to the total volume of the whole system, is achieved. In addition to the traction battery 1, the whole system also comprises the condensing device outside of the housing device 2 and connecting hoses between the housing device 2 and the condensing device.

In this embodiment, as a result of the specified filling ratio the liquid fluid 8 is at least partly in the microchannels 13 and thus at least this part of the microchannels 13 can already develop its cooling effect. The liquid fluid 8 is shown only in the plenum 7 in FIG. 1 for the sake of clarity. The liquid fluid 8 passes through the fluid passages 22 and through the inlet openings 20 from the plenum 7 into the microchannels 13, and thus, during operation, the microchannels 13 are partly filled with the liquid fluid 8 in their lower region with respect to the vertical direction 16. The lower region of the microchannel structures 12 with respect to the vertical direction 16 is thus dipped into the liquid fluid 8, whereby fluid contact of the microchannels 13 with the liquid fluid 8 is established. In an alternative embodiment, there is no liquid fluid 8 in the microchannels 13.

During operation, i.e. during charging or discharging of the traction battery 1, heat is produced in the battery cells 3. The heat is partially transferred from the battery cells 3, via their side walls, directly to the liquid fluid 8 in the microchannels 13. In addition, heat is transferred, to a small extent, from the side walls of the battery cells 3 to the adjoining evaporation elements 10 or to their evaporation bodies 11. This heat is then further transferred from the evaporation body 11 in question to the liquid fluid 8 via the microchannels 13.

In this embodiment, the indicated filling ratio has the effect that, even before boiling operation, the microchannels 13 are wetted with the liquid fluid 8. During boiling operation, the boiling of the liquid fluid 8 in the microchannels 13 and the rising of the evaporated fluid in the microchannels 13 cause liquid fluid 8 to be entrained, which wets the insides of the microchannels 13. Good, preferably complete, wetting of the insides of the microchannels 13 is thereby achieved, so that the wetted regions contribute to the cooling of the battery cells 3. During operation, heat is transferred from the battery cells 3 to the liquid fluid 8, and thus the liquid fluid 8 evaporates in the microchannels 13.

Liquid fluid 8 is fed into the microchannels 13 as a result of the flow of the liquid fluid 8 through the inlet opening 20 or through the inlet openings 20 from the bottom region 6 of the housing body 4 into the microchannels 13, and thus, in this embodiment, evaporated fluid 8 is replaced.

After the evaporation, the gaseous fluid 8 is conducted, via the outlet, into the condensing device. There, the gaseous fluid condenses by releasing heat to the environment. A fluid circuit which ideally is closed is formed. The condensed fluid returns, via the inlet, to the housing device 2. The fluid 8 can be actively or passively circulated.

FIGS. 3 and 4 show a traction battery 1 and a housing device 2 according to a second embodiment of the present invention. Here as well, the housing device 2 is part of the traction battery 1.

The traction batteries 1 and the housing devices 2 of the first and second embodiments are largely identical, and therefore mainly differences between the traction batteries 1 and the housing devices 2 of the first and second embodiments are described below. Accordingly, the same reference signs are used for components of the same type or for identical components. In case of doubt, details of the traction battery 1 and of the housing device 2 of the second embodiment which are not specified correspond, if required, to those of the first embodiment.

As is shown in FIGS. 3 and 4, in the second embodiment the battery cells 3 are combined to form battery modules 27 each having a plurality of battery cells 3, and in each of the receiving positions a battery module 27 is received. Accordingly, in each receiving position a plurality of battery cells 3 is jointly received. The battery module 27 comprises two end plates 28, which are arranged along side walls of outer battery cells 3. The end plates 28 combine the battery cells 3 to form the battery module 27, and the end plates 28 fix the individual battery cells 3 therein. In the battery module 27, the side walls of the battery cells 3 are adjacent to each other. An evaporation element 10 is arranged in an end region of the battery cells 3 of the battery module 27. The battery cells 3 are thus jointly oriented in their longitudinal direction 14 in the receiving position and in the battery module 27 such that their end regions lie on a straight line. Thus, in the traction battery 1, head-side contact of the battery cells 3 of the battery module 27 with the evaporation element 10 arranged there is established.

Accordingly, in contrast to the evaporation element 10 of the first embodiment, in the evaporation element 10 of the second embodiment the microchannel structures 12 are open only at one of the two side surfaces 33 of the evaporation elements 10 and extend from said side surface 33 in the transverse direction into the evaporation element 10 in question. The microchannels 13 are formed in the assembled state by the arrangement of the evaporation element 10 with the corresponding side surface 33 along the battery cells 3. Thus, in the assembled state the side surface 33 of the evaporation element 10 with the open microchannel structures 12 is bounded and also closed by the battery cells 3 adjoining the side surface 33. Otherwise, the evaporation element 10 of the second embodiment corresponds to the evaporation element 10 of the first embodiment.

As is clear from FIG. 4 in particular, the evaporation element shown there has a longitudinal extent which is greater than a length of the battery cells 3 arranged in the battery module 27, i.e. the evaporation element 10 has a longitudinal extent which is greater than that of the battery cells 3 of the battery module 27. The evaporation element 10 thus extends along the head sides of the adjacently arranged battery cells 3 of the battery module 27 and beyond this arrangement. The battery module 27 also comprises end plates 28, between which the battery cells 3 are retained, such that a mechanical unit is formed. The evaporation element 10 in question is preferably designed such that it extends at least into a region of the end plates 27 or even therebeyond. In the end plates 28, fastening holes 29 are formed, which extend in the vertical direction 16 and through which the battery module 27 is attached to the housing body 4 by means of fastening elements, which are not shown.

The evaporation element 10 has, at its top, a stop element 26, which limits the insertion of the evaporation element 10. When the evaporation elements 10 are inserted, the stop element 26 comes into contact with a top of the battery cells 3 received in the receiving positions. The stop element 26 is simultaneously used as a connecting element which brings about positioning and retention of the struts 17. In this embodiment, the connecting element 26 is formed at the upper end of the microchannel structures 12 with respect to the vertical direction 16.

In an alternative embodiment, the evaporation element 10 forms a wall region of the housing body 4, i.e. a structural part of the housing device 2.

FIG. 5 shows a traction battery 1 and a housing device 2 according to a third embodiment of the present invention. Here as well, the housing device 2 is part of the traction battery 1.

The traction batteries 1 and the housing devices 2 of the first and third embodiments are largely identical, and therefore differences between the traction batteries 1 and the housing devices 2 of the first and third embodiments are described below. Accordingly, the same reference signs are used for components of the same type or for identical components. In case of doubt, details of the traction battery 1 and of the housing device 2 of the third embodiment which are not specified correspond, if required, to those of the first embodiment.

The housing devices 2 of the first and third embodiments differ in the support of the battery cells 3 and evaporation elements 10 in the housing body 4. The housing device 4 of the third embodiment does not have a supporting plate 21. Instead, the battery cells 3 and evaporation elements 10 are jointly framed in a manner not shown and are attached to the housing body 4 by means of end-arranged retaining elements 30. For this purpose, two mounting holes 31 extending in the vertical direction 16 are formed in each retaining element 30. The retaining elements 30 are screwed in the housing body 4 by means of mounting screws 32 through the mounting holes 31.

FIG. 6 shows a traction battery 1 and a housing device 2 according to a fourth embodiment of the present invention. Here as well, the housing device 2 is part of the traction battery 1.

The traction batteries 1 and the housing devices 2 of the first and fourth embodiments are largely identical, and therefore differences between the traction batteries 1 and the housing devices 2 of the first and fourth embodiments are described below. Accordingly, the same reference signs are used for components of the same type or for identical components. In case of doubt, details of the traction battery 1 and of the housing device 2 of the fourth embodiment which are not specified correspond, if required, to those of the first embodiment.

The traction battery 1 and the housing device 2 of the fourth embodiment differ from those of the first embodiment by virtue of the use of an evaporation element 10 which corresponds to the evaporation element 10 of the second embodiment.

Accordingly, in the evaporation element 10 of the fourth embodiment the microchannel structures 12 are open only at one of the two side surfaces 33 of the evaporation elements 10 and extend from said side surface 33 in the transverse direction into the evaporation element 10 in question. In the assembled state, the microchannels 13 are formed by the arrangement of the evaporation element 10 with the corresponding side surface 33 along the battery cells 3. Thus, in the assembled state the side surface 33 of the evaporation element 10 with the open microchannel structures 12 is bounded and also closed by the battery cells 3 adjoining the side surface 33. Otherwise, the evaporation element 10 of the second embodiment corresponds to the evaporation element 10 of the first embodiment.

The evaporation element 10 of the fourth embodiment likewise has, at its top, a stop element 26, which limits the insertion of the evaporation element 10. When the evaporation elements are inserted, the stop element 26 comes into contact with a top of the battery cells 3 received in the receiving positions. In this embodiment, the connecting element 26 is formed at the upper end of the microchannel structures 12 with respect to the vertical direction 16. In the stop element 26, retaining holes 34 are formed, which extend through the stop element 26 in the vertical direction. The retaining holes 34 are arranged in a region of the stop element 26 that does not cover any battery cell 3. Thus, with the evaporation element of the fourth embodiment, a battery module 27 having a plurality of adjacent battery cells 3 can be formed, wherein, between adjacent battery cells 3, an evaporation element 10 of the first embodiment is arranged, and the evaporation element of the fourth embodiment is in the form of a module capping element and forms both ends of the battery module 27. By means of the retaining holes 34 of the corresponding stop elements 26 of the evaporation elements 10 of the fourth embodiment, the battery module 27 can be mounted and can be fastened, for example, to the housing body 4.

FIG. 7 shows a traction battery 1 and a housing device 2 according to a fifth embodiment of the present invention. Here as well, the housing device 2 is part of the traction battery 1.

The traction batteries 1 and the housing devices 2 of the first and fifth embodiments are largely identical, and therefore differences between the traction batteries 1 and the housing devices 2 of the first and fifth embodiments are described below. Accordingly, the same reference signs are used for components of the same type or for identical components. In case of doubt, details of the traction battery 1 and of the housing device 2 of the fifth embodiment which are not specified correspond, if required, to those of the first embodiment.

The traction battery 1 and the housing device 2 of the fifth embodiment differ from those of the first embodiment by virtue of the design of the evaporation device 9. The evaporation device 9 of the fifth embodiment likewise comprises a plurality of evaporation elements 10, which correspond to those of the first embodiment but each have a smaller extent in the longitudinal direction 14. In addition, the evaporation device 9 has structural elements 35 for joint arrangement between, in each case, two evaporation elements 10 in the longitudinal direction 14 along the battery cells 3. The structural element 35 is in contact with the adjacent battery cells 3 in question, and thus support of the battery cells 3 is formed. The evaporation elements 10, in contrast, are arranged between the adjacent battery cells 3 with slight play and therefore are not in direct mechanical contact therewith. There is a small distance between the battery cells 3 and the evaporation elements 10, and the distance is chosen to be so small that passage of liquid fluid 8 between the evaporation body 11 and the battery cells 3 is prevented.

FIG. 8 shows a traction battery 1 and a housing device 2 according to a sixth embodiment of the present invention. Here as well, the housing device 2 is part of the traction battery 1.

The traction batteries 1 and the housing devices 2 of the first and sixth embodiments are largely identical, and therefore differences between the traction batteries 1 and the housing devices 2 of the first and sixth embodiments are described below. Accordingly, the same reference signs are used for components of the same type or for identical components. In case of doubt, details of the traction battery 1 and of the housing device 2 of the sixth embodiment which are not specified correspond, if required, to those of the first embodiment.

The traction battery 1 and the housing device 2 of the sixth embodiment differ from those of the first embodiment by virtue of the design of the evaporation device 9. The evaporation device 9 of the sixth embodiment has a plurality of evaporation elements 10, which each extend along a plurality of battery cells 3 and, in the assembled state, are arranged adjacent to each other. The evaporation elements 10 each have a plurality of intermediate elements 36, which extend parallel to each other from a connecting body 37. In the assembled state, the intermediate elements 36 each extend in the vertical direction 16 between two adjacent battery cells 3, and the connecting bodies 37 of adjacent evaporation elements come into contact with each other along a contact edge 38. This results in desired positioning of the intermediate elements 36 of adjacent evaporation elements 10 at specified distances from each other. The microchannel structures 12 are formed in the specified distances between the intermediate elements 36 of the adjacent evaporation elements 10, and therefore, in the assembled state, the microchannels 13 are formed in the region of the microchannel structures 12 by the arrangement of adjacent evaporation elements 10 along adjacent battery cells 3. Thus, in the assembled state, the microchannel structures 12 formed between the evaporation elements 10 form the microchannels 13 between the adjacent intermediate elements 36 of adjacent evaporation elements 10 together with the adjoining battery cells 3. Between the mutually contacting connecting bodies 37 of the adjacent evaporation elements 10, recesses 39 are formed, which each define an inlet region 19 and form an inlet opening 20 for one of the microchannels 3.

In this embodiment, the evaporation elements 10 are of a comb-type design, the intermediate elements 36 being in the form of teeth and being arranged on the connecting body 37. In the assembled state, the connecting bodies 37 are arranged below the battery cells 3 with respect to the vertical direction 16. In this embodiment, the microchannel structures 12 are lined up in a plurality of rows in the evaporation device 9. The evaporation elements 10 have a transverse extent, i.e. extent in the direction of the adjacently arranged evaporation elements 10, which in principle can be freely chosen. This corresponds to the longitudinal direction 14 with respect to the battery cells 3. In the direction of the adjacently arranged battery cells 3, the evaporation elements 10 have a small extent so that the battery cells 3 can be arranged with small distances from each other and so that a compact battery module 27 is provided. In the assembled state in the traction battery 1, the intermediate elements 36 of the evaporation elements 10 are in contact, on the inside, i.e. on the sides facing the other intermediate elements 36 of the evaporation element 10 in question, with the adjacent battery cells 3. In this embodiment, the evaporation elements 10 have a greater vertical extent than the battery cells 3. The microchannel structures 12 extend over the total vertical extent of the battery cells 3.

FIG. 9 shows a traction battery 1 and a housing device 2 according to a seventh embodiment of the present invention. Here as well, the housing device 2 is part of the traction battery 1.

The traction batteries 1 and the housing devices 2 of the sixth and seventh embodiments are largely identical, and therefore differences between the traction batteries 1 and the housing devices 2 of the sixth and seventh embodiments are described below. Accordingly, the same reference signs are used for components of the same type or for identical components. In case of doubt, details of the traction battery 1 and of the housing device 2 of the seventh embodiment which are not specified correspond, if required, to those of the sixth embodiment.

The traction battery 1 and the housing device 2 of the seventh embodiment differ from those of the sixth embodiment by virtue of the design of the evaporation device 9. The evaporation device 9 of the seventh embodiment is largely identical to the evaporation device 9 of the sixth embodiment. In deviation therefrom, however, in the evaporation device 9 of the seventh embodiment the evaporation elements 10 are connected to each other at the connecting bodies 37, whereby a single-piece connecting body 37 is formed. Accordingly, a single-piece evaporation device 9 consisting of a plurality of evaporation elements 10 is formed. This results in exact positioning of the adjacent evaporation elements 10 relative to each other. Accordingly, in the one plane direction battery cells 3 are arranged between the intermediate elements 36 and in the other plane direction microchannel structures 12 for forming microchannels 13 are arranged between the intermediate elements 36.

### LIST OF REFERENCE SIGNS

1 Traction battery
2 Housing device
3 Battery cell
4 Housing body
5 Interior
6 Bottom region
7 Plenum
8 Liquid fluid
9 Evaporation device
10 Evaporation element
11 Evaporation body
12 Microchannel structure
13 Microchannel
14 Longitudinal direction
15 Transverse direction
16 Vertical direction
17 Support bar, strut
18 Connecting element
19 Inlet region
20 Inlet opening
21 Supporting plate
22 Slot, fluid passage
23 Filling element
24 Lower shell
25 Upper shell
26 Stop element, connecting element
27 Battery module
28 End plate
29 Fastening hole
30 Retaining element
31 Mounting hole
32 Fastening screw
33 Side surface
34 Retaining opening
35 Structural element
36 Intermediate element
37 Connecting body
38 Contact edge
39 Recess

1. A housing device for a traction battery with fluid-based cooling, of a vehicle, which traction battery has a plurality of battery cells, the housing device comprising:
a housing body (II), including:
an enclosed interior with a plurality of receiving positions for receiving the plurality of battery cells, and
a bottom region configured to receive liquid fluid and
an evaporation device for evaporating the liquid fluid,
wherein:
the evaporation device has a plurality of microchannel structures for forming microchannels,
the microchannel structures extend in a vertical direction in an assembled state and have, in a lower region thereof with respect to the vertical direction, at least one inlet opening for receiving the liquid fluid from the bottom region of the housing body, and
during operation, the liquid fluid enters the microchannels through the at least one inlet opening and heat is transferred from the battery cells to the liquid fluid in the microchannels, whereby the liquid fluid evaporates in the evaporation device.

2. The housing device according to claim 1, wherein:
the evaporation device has at least one evaporation element ROOM, and
the at least one evaporation element includes at least one evaporation body with the plurality of microchannel structures for forming the microchannels.

3. The housing device according to claim 2, wherein:
the plurality of microchannel structures is open at at least one side surface of the at least one evaporation element (10) in and
the microchannels are formed in the assembled state via alignment of the at least one evaporation element with at least one of side surface thereof along one or more battery cells.

4. The housing device according to claim 3, wherein:
the plurality of microchannel structures is open at both side surfaces of the at least one evaporation element, and
the microchannels are formed via arranging the at least one evaporation element with both side surfaces along the plurality of battery cells.

5. The housing device according to claim 2, wherein:
the plurality of microchannel structures is closed along both side surfaces of the at least one evaporation element, such that the microchannels are formed within the at least one evaporation body, and
the at least one evaporation body is in thermally conductive contact with at least one battery cell of the plurality of battery cells during the operation.

6. The housing device according to claim 2, wherein:
the evaporation device has at least one structural element, and
the at least one structural element is arranged, with the at least one evaporation element, along one or more battery cells.

7. The housing device according to claim 2, wherein the at least one evaporation element is arranged in a region between at least two receiving positions for the plurality of battery cells.

8. The housing device according to claim 2, wherein:
the plurality of receiving positions are arranged for receiving of the plurality of battery cells such that received battery cells are at least partly arranged parallel in a row, and
the at least one evaporation element is arranged in an end region of one or more receiving positions for the row of the received battery cells.

9. The housing device according to claim 8, wherein the at least one evaporation element has a longitudinal extent which is greater than a length of the received battery cells at least partly arranged in the plurality of receiving positions in the row.

10. The housing device according to claim 1, wherein the evaporation device has a plurality of evaporation elements, which each extend along the plurality of battery cells and, in the assembled state, are arranged adjacent to each other, and
wherein:
each of the plurality of evaporation elements has a plurality of intermediate elements which, in the assembled state, each extend in the vertical direction between two adjacent battery cells,
respective plurality of intermediate elements of adjacent respective evaporation elements are arranged at specified distances from each other,
the microchannel structures are formed in the specified distances between the respective plurality of intermediate elements of the adjacent respective evaporation elements, and
the microchannels are formed in the assembled state via arrangement of the respective evaporation elements along the plurality of battery cells.

11. The housing device according to claim 10, wherein the plurality of evaporation elements is interconnected, or the plurality of evaporation elements is interconnectable via a coupling apparatus.

12. The housing device according to claim 10, wherein:
each of the plurality of evaporation elements has at least one connecting body, from which the respective plurality of intermediate elements extend,
in the assembled state, the at least one connecting body extends along the plurality of battery cells, and
in the assembled state, the at least one connecting body is arranged below and/or above the battery cells with respect to the vertical direction.

13. The housing device according to claim 1, wherein the microchannels at least partly have a surface structure at which the liquid fluid evaporates, such that bubbles are formed, the surface structure being formed in the lower region in the microchannels which is near the bottom region.

14. The housing device according to claim 1, wherein the at least one inlet opening has a cross-section which is smaller than a cross-section of a corresponding microchannel structure.

15. The housing device according to claim 1, wherein:
the at least one inlet opening includes a through-hole in an inlet region of the microchannel structure, or
the at least one inlet opening includes a lateral recess in the inlet region of the microchannel structure.

16. The housing device according to claim 2, wherein the at least one evaporation element includes an insertion element for insertion into the housing body.

17. The housing device according to claim 1, wherein the evaporation device is configured to support the plurality of battery cells against each other or to support the plurality of battery cells on the housing body.

18. The housing device according to claim 2, wherein the at least one evaporation body of the at least one evaporation element is designed as a support element for supporting the plurality of battery cells against each other or for supporting the plurality of battery cells on the housing body.

19. The housing device according to claim 18, wherein the at least one evaporation element has a grate structure, and
wherein the at least one evaporation body has a plurality of struts running in the vertical direction.

20. The housing device according to claim 1, wherein the housing device has a supporting plate, which extends in a horizontal plane in the housing body and forms a vertical support for the plurality of battery cells and/or the evaporation device, and
wherein the supporting plate has at least one fluid passage between a plenum, which is located therebelow, and the plurality of microchannel structures.

21. The housing device according to claim 2, wherein the at least one evaporation element forms a wall region of the housing body.

22. The housing device according to claim 1, wherein the housing device has at least one filling element, which is arranged in the interior enclosed by the housing body.

23. The housing device according to claim 1, wherein an outlet for evaporated, gaseous fluid and an inlet for condensed, liquid fluid are formed on the housing body.

24. The housing device according to claim 1, the housing device housing the traction battery, and the housing device being implemented in the vehicle with the fluid-based cooling, the housing device further comprising:
the plurality of battery cells received in the receiving positions in an interior of the housing body, and
the liquid fluid, which is received in the bottom region of the housing body.

25. The housing device according to claim 24, wherein the traction battery is filled with the liquid fluid at a filling ratio of a whole system at a system temperature of 50° C. of 20 to 60 volume percent, in relation to a total volume of the whole system.

26. The housing device according to claim 24, wherein the traction battery has a quality sensor, which is in contact with the liquid fluid at least during the operation and senses at least one electrical property of the liquid fluid including a breakdown voltage an electrical conductivity of the liquid fluid.
